(19) United States
(12) Patent Application Publication
(10) Pub. No.: US 2006/0201335 A1
(43) Pub. Date: Sep. 14, 2006

(54) Roaster for seasoning marine algae

(76) Inventor: Jun-Chul Kim, Kyunggi -Do (KR)

Correspondence Address: GREENBLUM & BERNSTEIN, P.L.C., 1950 ROLAND CLARKE PLACE, RESTON, VA, 20191, US

(21) Appl. No.: 10/565,197

(22) PCT Filed: Jun. 9, 2004
(86) PCT No.: PCT/KR04/01376

§ 371 Date: Jan. 20, 2006

(30) Foreign Application Priority Data
Jul. 24, 2003 (KR) 10-2003-0051085

(51) Int. Cl. A47J 37/12

(52) U.S. Cl. 99/403

(57) ABSTRACT

The present invention is related to the roaster for seasoning marine algae, comprising a main body comprised of an supplying unit formed to add raw material into an upper part thereof and an opening part capable to slidingly and horizontally insert a container into a lower part thereof; a roasting container formed onto an inner, an upper part of the main body and configured to discharge downward the raw material through a discharging gate after keeping the raw material sealed for a predetermined time; and a condiment collection unit to store a class of condiments including various kinds of seasoning, sesame oil, and flavor, and to detachably collect a plurality of condiment containers for selectively providing a certain amount of seasoning necessary into the collection cooking container.

### FIELD OF THE INVENTION

The present invention is related to a roaster for seasoning marine algae, and especially, to a roaster for seasoning marine algae improved to minimize inconveniences that take place due to frequently washing or replacing a container in its clean condition after completing a process, to prevent a taste and quality of processed foodstuffs from degrading and raw material and seasoning from being burned to stick to an inner side wall of the container during a process, and to enhance workability by reducing a size in height of a main body in a roaster equipment.

### BACKGROUND OF THE ART

Generally, it is well known that marine algae such as layer, sea lettuce, brown seaweed, duckweed, or hizki, contains a large quantity of nutritive substance useful for the human body and is a kind of food having excellent effect in promoting health. Recently, various kinds of convenience food (hereinafter “kimjaban”) adjusted to the taste for consumer by adding seasoning, flavor or spice to various marine algae are marketed.

Until now, although the kimjaban was manually cooked by heating to roast and adding raw food and seasoning thereon with cooking oil on frying pan, a variety of roasters for seasoning marine algae capable of convenience and simplicity to cooking have recently been developed and come into wide use.

As a traditional roaster for seasoning algae, Korean utility model registration No. 2001-0040730, titled “Roast machine,” has been proposed. This machine is two-layer stacked to have a container structure equipped with a roasting container and a collection container respectively in the upper and lower parts of its inner main body. As a main part of equipment that heats and roasts the raw foodstuffs and seasoning by activating a heater installed in the lower part and rotating an agitator simultaneously after an adequate amount of raw foodstuffs, seasoning and flavor are supplied through a supplying gate, the roasting container is designed to take a processed raw material out through a discharging gate in the lower part and then collect the processed material in the collection container, resulting in all cooking process being simultaneously done in a single space.

Therefore, as a cooking process is simultaneously done in the roasting container without having separate roast and seasoning processes by heating and stirring, taster's health can be damaged by burned food and taste and quality of the processed food is deteriorated because added seasoning and flavor are stuck to the inner wall of the roasting container even in such a short time of cooking. In addition, after operating for a fixed time, there is a need to re-assemble or replace the roasting container with a washed one, which eventually acts, as a bad effect, to shorten the life span of the equipment.

Further, since savory favor and ingredient in peculiarity is vaporized on heating when flavor such as sesame oil is added, it is necessary that another process, a kind of mixing manipulation by adding again flavor like sesame oil to a processed material after the processed material is collected in a collection container to maintain a taste of the processed food, should be applied for preventing vaporization.

Likewise, in providing a variety of condiments and raw material for roasting there are many limitations to embodying an auto process system fitted to mass production and to uniformly maintaining a taste of a processed food because a uniform, quantitative supply of raw material is hardly realized by relying on manual work by an operator.

In this respect, “A roaster for marine algae,” the Korean patent application No. 2002-0048889, has been proposed by the same inventor of the present invention to deal with problems as mentioned above.

The above invention discloses a three layer-stacked container structure, each layer being equipped with a condiment mixing container and a collection container in the upper, middle, and lower parts of the inner wall of the main body. With this configuration, the operator fixedly puts measured raw material through a supplying gate in the upper part and then operates a roasting process by heating all around said raw material with the heater in the lower part and simultaneously rotating agitator. Then, the roasted material is supplied into the condiment mixing container through a discharging gate positioned in the lower part of the roasting container, the condiment mixing container lacking a heater. Subsequently, said roasted raw material is mixed with various condiments through a condiment feeder placed on one side of main body by rotating an agitator. Thus, it is designed in such a way that said cooked processed raw material is eventually extracted from a collection container which collects the cooked processed food through the discharging gate placed in the lower part of the condiment mixing container.

Therefore, according to the above roaster, the problem in the conventional roaster that parts of condiment in the roasting container are lengthened to stick to the roasting container, and burned and thus flavor or taste of flavor is vaporized to vanish when heating is applied, is completely solved.

However, while there are several merits on function aspects in the foregoing roaster as discussed above, another problem resides in that workability by operator is deteriorated due to an increase of main body height by the fact that the three layered-stack type structure is realized inconvenient by operator, who operates the foregoing roaster with an extra pedestal installed.

In addition, there is a problem with the foregoing roaster that deteriorates a quality of product by causing the raw material for process to be finely chopped as the next process is advanced with that processed raw material to drop the processed material twice, firstly to the condiment mixing container and secondly to the collection container.

### DISCLOSURE OF THE INVENTION

The present invention is directed to a roaster for seasoning marine algae to solve the foregoing problems. It is an object to maintain an peculiar flavor and taste of spice such as sesame oil after completing a process, to prevent taste and quality as a processed food from being deteriorated as the processed raw material and parts of condiment are lengthened to stick to the roasting container and burned, as well as to provide a fitness for mass production by maintaining a system to realize an automation for all process.

Further, it is another object of the present invention to provide a roaster for seasoning marine algae improved to easily enhance workability by reducing a height of the main body as well as to minimize an inconvenience of management to wash or to replace the roaster after operating for a predetermined time.

In constructing a condiment collection unit possessed of both for collecting mixed condiment as a tool for minimizing a height of the main body, another aspect of the present invention is to freely detach without being interrupted with an inner agitator when operating the condiment collection unit containing a processed food and to maintain a product quality by minimizing a phenomenon that product is finely chopped, caused by reducing a step of raw material's falling and to provide a roaster for seasoning marine algae

According to an embodiment of the present invention, the roaster for seasoning marine algae comprises a main body including an supplying unit formed to add raw material into an upper part thereof and an opening part capable of slidingly and horizontally inserting a container into a lower part thereof; a roasting container positioned in an inner, upper part of the main body and configured to discharge downward the raw material through a discharging gate after keeping the raw material sealed for a predetermined time; a cooking oil feeder placed in a side of the roasting container to automatically supply a fixed quantity of cooking oil for the raw material added therein to easily be agitated without rubbing; a heater for heating the roasting container at an established temperature for the predetermined time; a roasting agitator configured for both ends of a pivotal pole thereof to be supportably placed across the roaster to rotate and for agitating a collected raw material to equally be heated in the roaster rotated at a fixed velocity for the predetermined time with a power transmission attached thereto; a shutter rotating clockwise and counter-clockwise with a separate power transmission at a fixed angle for the discharging gate to stay open for a predetermined time after sealing the discharging gate of the roaster for a fixed time; a collection cooking container for collecting a class of condiments including various kinds of seasoning, sesame oil and flavor each selectively dispersed from a plurality of condiment containers and for receiving a firstly processed raw material which was collected through the supplying unit of the main body and discharged through the discharging gate of the roaster; a condiment collection unit to store a class of condiments including various kinds of seasoning, sesame oil and flavor, and to detachably collect a plurality of condiment containers for selectively providing a certain amount of seasoning necessary into the collection cooking container; a cooking agitator configured for both ends of a pivotal pole thereof to be supportably placed across the collection cooking container and coupled thereon to rotate at a fixed rate with a separate power transmission such that the processed material collected into the collection cooking container can be uniformly mixed with the class of condiments and each wing of the second agitator can be positioned in upper direction at the time of completion in the process by each wing of the second agitator being arranged at least at a certain angle toward a horizontal plane to be easily released without the collection cooking container's being interrupted when it is necessary for the collection cooking container to be released; and a controlling unit electrically connected thereof to control each operation in sequence.

In addition, it is preferable to install a guide rail in both sides of the inner part of the supplying unit in the main body to guide the collection cooking container when the collection cooking container is inserted and released.

Further, it is preferable to mount a sensor on the back side of inner part of the supplying unit to detect whether or not a stable insertion is made when the collection cooking container is collected.

Further, it is preferable that the roasting agitator is comprised of a pair of at least two wings, each wing including a wing body and a wing member, the wing member coupled with one end of the wing body, extended in a longitudinal direction to the pivotal pole, and formed to have a twist at one end facing one end of the other wing member, the wing body extendedly arranged by direction of a radius from the pivotal pole with maintaining 180 degree of an interval angle to the other.

In addition, it is preferable that the shutter is comprised of a sealing plate to cover the discharging gate incised in a predetermined width in a longitudinal direction to the roaster; a pivotal pole formed in a longitudinal direction on a side of the sealing plate, the pivotal pole having both ends pivotally coupled to the main body such that the sealing plate circles at a predetermined angle; a pair of light sensors to detect a rotating position of the pivotal pole, each sensor attached around the pivotal pole to one wall of the main body supporting the pivotal pole; a light isolating pole circulating with the pivotal pole to prevent each light sensor radiating and receiving the light, positioned at one end of the pivotal pole in the one wall of the main body with the light sensor attached thereto.

It is also preferable that the collection cooking container is made of transparent plastics for a mixing and cooking process to be checked outside by an operator. It is also preferable that that the roasting agitator is comprised of a pair of at least two wings, each wing including a wing body and a wing member, the wing member coupled with one end of the wing body, extended in a longitudinal direction to the pivotal pole, and formed to have a twist at one end facing one end of the other wing member, the wing body extendedly arranged by direction of a radius from the pivotal pole with maintaining 178 degree of an interval angle to the other.

### BRIEF DESCRIPTION OF DRAWINGS

FIG. 1 shows a perspective view of a roaster for seasoning marine algae according to an embodiment of the present invention.

FIG. 2 shows a right-side sectional view simplifying an inner structure for a roaster for seasoning marine algae according to an embodiment of the present invention.

FIG. 3 shows a front-side sectional view simplifying an inner structure for a roaster for seasoning marine algae according to an embodiment of the present invention.

FIG. 4 shows a perspective view of a cooking agitator applied in a roaster for seasoning marine algae according to an embodiment of the present invention.

FIG. 5 shows a plane view of a cooking agitator applied in a roaster for seasoning marine algae according to an embodiment of the present invention.

FIG. 6 is a side sectional view illustrating installation of a cooking agitator and extraction structure of a collection cooking container applied in a roaster for seasoning marine algae according to an embodiment of the present invention.

### BEST MODE FOR CARRYING THE INVENTION

A roaster for seasoning marine algae according to a preferred embodiment of the present invention is hereinafter described in more detail with attached drawings.

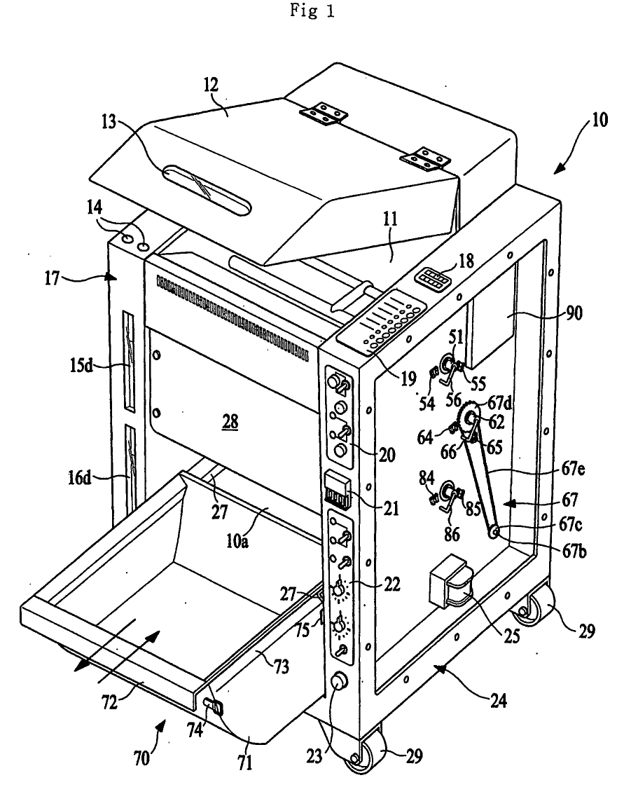

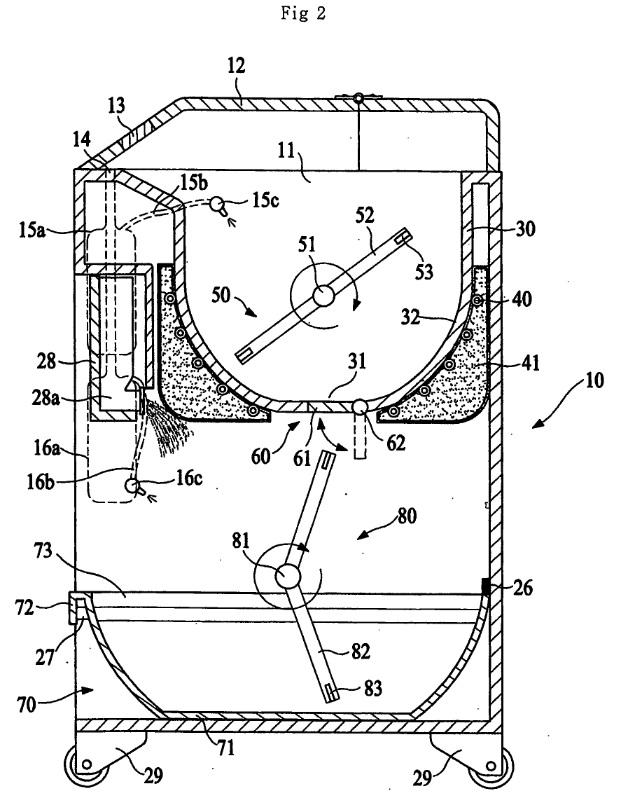

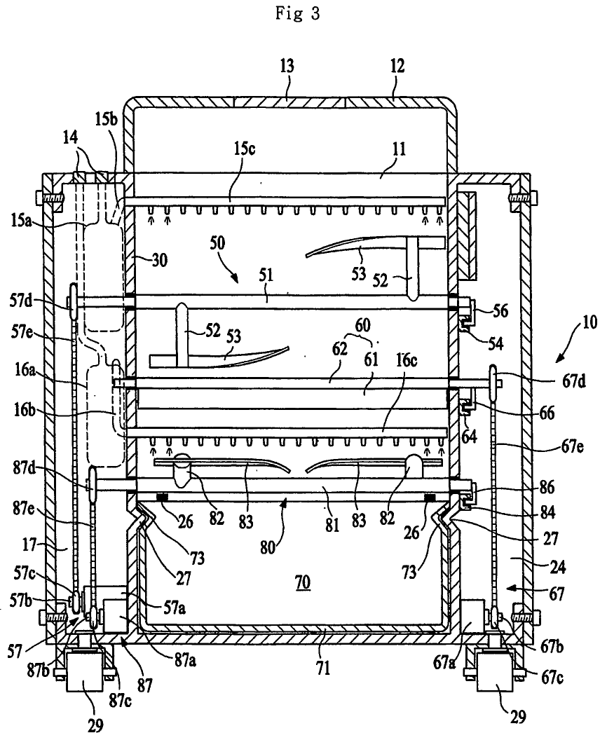

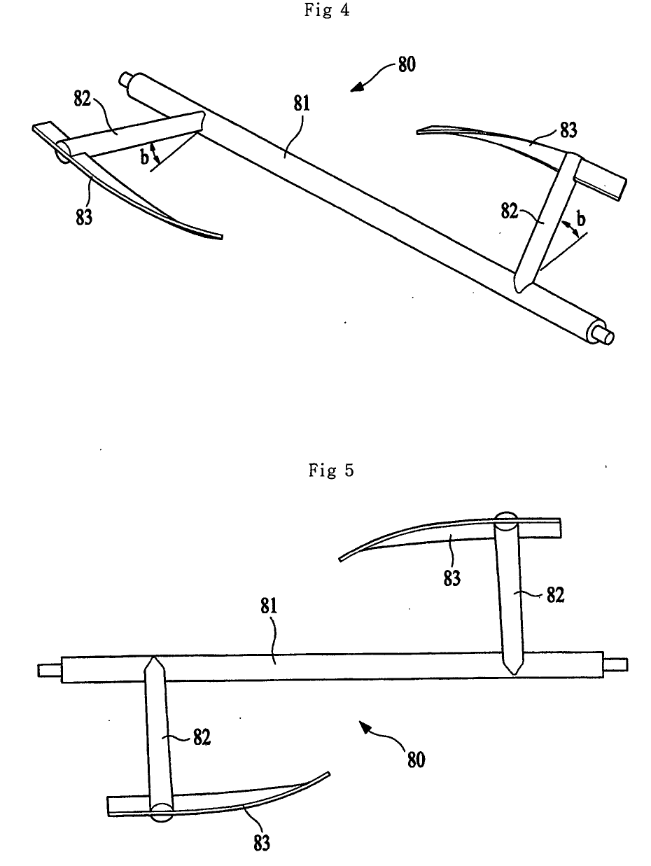

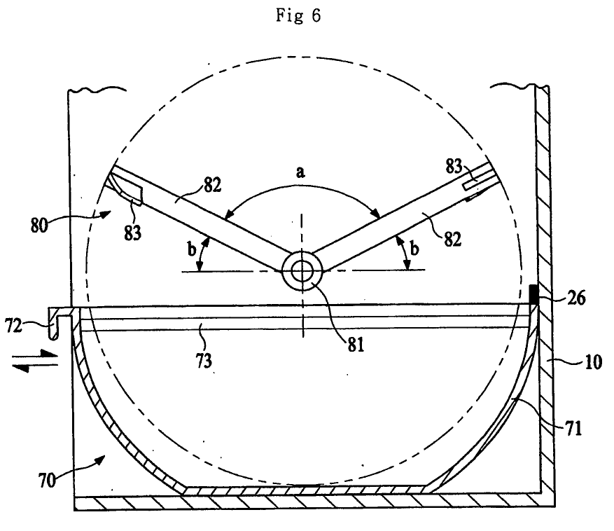

The roaster for seasoning marine algae according to the preferred embodiment of the present invention is shown in FIGS. 1 through 6. FIG. 1 shows an approximate perspective view of the roaster with an outward structure, and FIGS. 2 and 3 show, respectively, a right-side and a front-side cross-sectional view simplifying the inner structure. FIGS. 4 and 5 show, respectively, a cross-sectional and a plane view of a cooking agitator (80) applied to the embodiment of the present invention and FIG. 6 shows an approximate sectional view to explain the installed structure of the cooking agitator (80) and extracted structure of a collection cooking container (70).

As illustrated in FIGS. 1 through 3, the roaster for seasoning marine algae according to the embodiment of the present invention is comprised of a main body (10); a roasting container (30) placed in the main body; a heater (40) attached to the roasting container (30); a roasting agitator (50); a shutter (60) supplying a discharging gate (31) of the roasting container (30); a collection cooking container (70) freely detachable to operate a seasoning process mixing condiments to the roasted raw material placed in the lower of the roasting container (30); a cooking agitator (80) attached to the upper of the collection cooking container (70); a controller (90) to operate in order each process electrically connected to the each part with operator's need.

The more detailed illustration reciting each element of the embodiment in the present invention is as follows. The main body (10) includes the supplying/closing unit (11) to input the raw material in the upper part thereof, an opening unit (10a) capable to slidingly and horizontally insert a container into a lower part thereof, a mechanical room (17), controlling room (24), and the condiment collection unit (28) in both sides and at the middle, and a caster (29) in the other side of the main body (10) attached to easily move.

In the mechanical room (17), as shown in FIGS. 1 and 3, a pivotal pole (51) of the agitator for roasting in a roasting container (30) and a power transmission (57), (87) to rotate the pivotal pole (51) of the cooking agitator (80) in the collection cooking container (70) is installed. Meanwhile, although a chain (57e), (87e) is used as the power transmission (57) (87), the power transmission is not limited to the chain. As the power transmission (57), (87) is ordinary one, it is supposed to work in such a way that the agitator (50), (80) is rotated at a reduced speed by delivering a rotating power of a driving sprocket (57c), (87c) installed at a motor axis (57b), (87b) of each motor (57a), (87a) to a driven sprocket (57d), (87d) of each pivotal pole (51), (81) by each chain (57e), (87e).

In addition, an oil feeder unit is installed in the mechanical room (17) for automatically supplying oil with a fixed amount in order that raw material added in the roasting container (30) is smoothly rotated without a friction. Namely, a cooking oil container (15a) is arranged to supply cooking oil such as refined corn oil in the roasting container (30) and a sesame oil container (16a) to supply sesame oil in the collection cooking container (70) for adding taste and flavor to roasted raw material. The cooking oil and sesame oil containers (15a), (16a) are connected to each oil feeder gate (14) formed in the upper of the main body wherein the cooking oil and sesame oil are extracted and sprayed to the nozzles (15c) and (16c), which are installed in the roasting container (30) and collection cooking container (70) through the pipes (15b) and (16b). In the pipes (15b) and (16b), each of pumps (not illustrated in drawings) is installed to extract oil to the nozzles (15c) and (16c). Also, in the front of the main body (10) of the mechanical room (17), windows (15d) and (16d) are arranged to check the oil residue in the cooking oil container (15a) and sesame oil container (16a).

In the control room (24), the controller (90) in the type of PCB, a transformer (25), and the power transmission (67) are installed to open and close the shutter (60). The power transmission (67) is embodied to have the same structure as the power transmission (57), (87). As discussed above, the sealing plate (61) is rotated at a reduced speed with a limited angle by delivering a rotating power of the driving sprocket (67c) installed in the axis (67b) of the motor with the chain (67e) to the driven sprocket (67d), which is fixed to the pivotal pole (62) of the shutter (60).

Also, various operating panels are formed to operate in such a way that operation by each unit is controlled by electrical connection with the controller (90). For example, the various operating panels, as illustrated in FIG. 1, are comprised of a panel for controlling roasting time (18), a panel for condiment setting (19), various switching panels (20), (21) and (22) and a power button (23). The panel for controlling roasting time (18) is one designating a time required to roast in the roasting container (30), and the panel for condiment setting (19) is for variously manufacturing products fitted for consumer's taste.

With this configuration, various flavors, such as sweet flavor, curry flavor, garlic flavor, kimchi flavor, soybean-paste flavor, and wasabi flavor can be obtained by adding or mixing applicable condiments in a fixed amount into the collection cooking container (70) with selective one-touch operation of a number of buttons when the operation is needed, each button electrically connected to open and close the condiment containers (28a), as various seasoning or flavors are stored in a powdered form in a number of the condiment containers (28a). Also, the switching panel (20) is comprised of a controlling power switch, a power lamp, a roasting-on switch, a discharging gate opening/closing switch and an operation closing switch. Another switching panel (21) is comprised of a setting unit to set up an execution time for each process and the other switching panel (22) is comprised of an oil selective switch, a seasoning switch, a roasting time set switch, a cooking time set switch and a heating-on switch. As the condiment container collection unit (28) herein is configured to store various kinds of seasoning or flavor and selectively supply for a limited amount of necessary seasoning into the collection cooking container (70), the condiment containers, as disclosed in FIGS. 1 and 2, are installed in the condiment container collection unit (28) positioned in the central-front side of the main body (10), the condiment containers arranged horizontally in a detachable case.

The closing cover (12) is equipped in the upper of the supplying unit (11) and a transparent window (13) is installed in the closing cover (12) to help a user look into the inside thereof.

Meanwhile, as illustrated in FIGS. 2 and 3, wherein the roasting container (30) formed in the upper of the inside of the main body (10) is functioned to discharge raw material through the discharging gate (31) after sealing the raw material collected through the supplying gate (11) for a predetermined time, the roasting container is configured to have an inner side (32) coated so that the raw material can be remain not lengthened to stick, the inner side contacting directly with processed raw material, and to have a heater (40) installed at the outer side and the shutter (60) in the discharging gate (31). As the heater (40) is one heating the roasting container (30) for a predetermined time at a fixed temperature, an outer side of the heater (40) is finally treated with an insulating material (41).

Also, the roasting agitator (50) coupled to the roasting container (30) is configured for both ends of a pivotal pole (51) thereof to be supportably placed across the roaster to rotate and for agitating a collected raw material to equally be heated in the roaster rotated at a fixed velocity for the predetermined time with a power transmission attached thereto, the roasting agitator connected to the pivotal pole (51) by the power transmission (57). As the roasting agitator (50) is comprised of a pair of at least two wings, each wing including a wing body and a wing member, the wing member coupled with one end of the wing body, extended in a longitudinal direction to the pivotal pole, and formed to have a twist at one end facing one end of the other wing member, the wing body extendedly arranged by direction of a radius from the pivotal pole with maintaining 180 degree of an interval angle to the other. Further, since the light isolating pole (56) is connected to the controlling room (24) of the pivotal pole (51) and the light sensors (54) and (55) are attached to the side wall of the main body (10) for controlling a rotation and stop of the pivotal pole (51), it is enabled to sense and to control its condition by that the light isolating pole (56) passes between a reception unit and a radiation unit of the light sensors (54) and (55).

The shutter (60), rotating clockwise and counter-clockwise with a separate power transmission at a fixed angle for the discharging gate to stay open for a predetermined time after sealing the discharging gate of the roaster for a fixed time, is comprised of a sealing plate (61) to cover the discharging gate incised in a predetermined width in a longitudinal direction to the roaster; a pivotal pole formed in a longitudinal direction on a side of the sealing plate (61), the pivotal pole having both ends pivotally coupled to the main body such that the sealing plate circles at a predetermined angle; a pair of light sensors (64) and (65) to detect a rotating position of the pivotal pole, each sensor attached around the pivotal pole (62) to one wall of the main body supporting the pivotal pole (62); a light isolating pole (66) circulating with the pivotal pole to prevent each light sensor radiating and receiving the light, positioned at one end of the pivotal pole in the one wall of the main body with the light sensors (64) and (65) attached thereto. A principle for control and operation is the same as that of the roasting agitator (50).

Meanwhile, the collection cooking container (70) is configured for collecting and mixing a class of condiments including various kinds of seasoning, sesame oil, and flavor each selectively dispersed from a plurality of condiment containers (28a) and then for receiving a firstly processed raw material collected through the supplying unit of the main body and discharged through the discharging gate (31) of the roaster, in which a guide rail (27) is installed in both sides of the inner part of the opening unit (10a) in the main body (10) to guide the collection cooking container (70) when the collection cooking container is inserted and released and a guide groove (73) is formed to slide in both sides of the container body (71) in the collection cooking container (70), corresponding to the guide rail (27). In addition, a handle grip (72) is formed to easily extract in the front of the collection cooking container (70), and each of a fixed unit (74) and a fixed hook (75) is installed to fix and to maintain a collection in intact condition after correctly inserting the collection cooking container (70) in the opening unit (10a) of the main body (10).

In the mean time, the sensor (26) is mounted on a rear side of an inner part of the opening unit (10a) to detect whether or not insertion is stably performed when inserting the collection cooking container (70). Further, it is more preferable that the collection cooking container (70) is made of transparent synthetic resin for a mixing and cooking process to be checked outside by an operator.

Meanwhile, the cooking agitator (80), as illustrated in FIGS. 4 through 6, is configured for both ends of a pivotal pole thereof to be supportably placed across the collection cooking container (70) and coupled thereon to rotate at a fixed rate with a separate power transmission such that the processed material collected into the collection cooking container can be uniformly mixed with the class of condiments and each wing of the second agitator can be positioned in upper direction at the time of completion in the process by each wing of the second agitator being arranged at least at a certain angle toward a horizontal plane to be easily released without the collection cooking container (70)'s being interrupted when it is necessary for the collection cooking container (70) to be released.

Namely, it is preferable that the cooking agitator for (80) is comprised of a pair of at least two wings, each wing including a wing body (82) and a wing member (83), the wing member (83) coupled with one end of the wing body (82), extended in a longitudinal direction to the pivotal pole (81), and formed to have a twist at one end facing one end of the other wing member (83), the wing body (82) extendedly arranged by direction of a radius from the pivotal pole (81) with maintaining 178 degree of an interval angle (a) to the other. In comparing with the roasting agitator (80), the cooking agitator (80) is the same in basic structure, except an interval angle (a) between agitator bodies (52) and (82) is different, and it is clear that the cooking agitator (80) is also configured to sense and to control its operation since the light isolating pole (56) and a pair of the light sensors (84) and (85) are coupled to one part and adjacent side wall of the controlling room (24) of the pivotal pole (51) in the cooking agitator (80).

The following is an example briefly illustrating operation of the roaster for seasoning marine algae according to the present invention embodying the structure as discussed above.

By operating a power button (23), the alternating voltage through a transformer (25) is supplied in a stable, fixed form (12V, 24V, 110V etc.) and a roasting process for raw material is initiated wherein the roasting agitator (50) is rotated in the roasting container (30) with marine raw material supplied through the supplying gate (11) in the upper unit and cooking oil simultaneously added as an operating control power switch, a heater-on switch, a cooking oil supplying switch, a roasting-on switch, and a control switch for heating temperature arranged in the switching panels (20), (21) and (22) are operated in accordance with operation condition such as operating roasting time, cooking time set up in advance.

A processing time during a roasting process is displayed by real time in a subtracted form on the display panel (18), and rotation of the agitator (50) is sensed by the light sensors (54) and (55). At this time, in case that the rotation of the roasting agitator (50) is interrupted due to the overload of the raw material put between the agitator (50) and the roasting container (30), a managing step is available on recognizing whether equipment is feasible or not by alarming the bell informing the overload state with a controller (90) processing an electrical signal transmitted from the light sensors (54) and (55).

As the roasting process for a predetermined time is finished, a firstly processed raw material in the roasting container (30) is discharged down to the collection cooking container (70) thereof, at the time of which the shutter (60) is opened and automatically closed after maintaining opening state for a predetermined time by sensing its operation condition with the light sensors (64) and (65).

Immediately after the firstly processed raw material is collected in the collection cooking container (70), the cooking agitator (80) is rotated with sesame oil and seasoning supplied and then a cooking process of mixing the raw material is initiated for a fixed time.

Likewise in the roasting process, a processing time for the cooking process is displayed by real time in a subtracted form on the display panel (18) and rotation of the cooking agitator (80) is sensed by the light sensors (84) and (85). At this time, in case that the rotation of the agitator (80) is interrupted due to the overload of the raw material put between the cooking agitator (80) and the collection cooking container (70), a managing step is available on recognizing whether equipment is feasible or not by alarming the bell informing the overload state with the controller (90) processing an electrical signal transmitted from the light sensors (84) and (85).

After both mixing and cooking process are finished for an pre-established time, the cooking agitator (80) is stopped with wing bodies of the agitator (82) in upward direction and thus, the operator can extract the collection cooking container (70) along with guide rail (27) of the main body (10).

Therefore, as illustrated above, it is possible to manufacture in bulk a uniform kimjaban of good quality by said roasting and cooking process in a separate form of two extended steps.

### INDUSTRIAL APPLICABILITY

As discussed above, according to the roaster for seasoning marine algae of embodied in the present invention, it is possible to manufacture in bulk a uniform kimjaban of good quality by realizing a full process-automatic system, in which various condiments and flavor in the form of solid powder, cooking oil or sesame oil necessary for roasting or cooking process are supplied each in a fixed amount, and by performing said roasting and cooking process in a separate form, it is available to maintain original flavor and taste of spice and sesame oil and to prevent processed raw material and seasoning from being lengthened to stick and burned so that taste and quality as a processed food can be maintained. Further, it is advantageous to minimize an inconvenience that takes place while in management such as washing apart a roaster or replacing after operating the roaster for a long time and to improve workability by reducing a size in its height of the main body, wherein the container structure is simply comprised of two layer-stacked form.

Further, the present invention is directed to a tool for reducing a size in height of the main body by constructing the collection cooking container designed both for collecting and mixing various condiments. In this configuration, when operating the collection cooking container storing the processed food, the cooking agitator is maintained in such a position in upward direction that it is practicable to freely detach the collection cooking container without being interrupted with the cooking agitator and to maintain a product quality by reducing a falling distance of the products during the cooking process so as to prevent products from being finely chopped.

Although the invention has been shown and described with reference to the certain preferred embodiment thereof, it will be understood by those skilled in the art that various changes in form and details may be made therein without departing from the spirit and scope of the invention as featured by the appended claims.

1. A roaster for seasoning marine algae, comprising:
a main body comprised of an supplying unit formed to add raw material into an upper part thereof and an opening unit capable of slidingly and horizontally inserting a container into a lower part thereof;
a roasting container formed onto an inner, upper part of the main body and configured to discharge downward the raw material through a discharging gate after keeping the raw material sealed for a predetermined time;
a cooking oil feeder formed in a side of the roasting container to automatically supply a fixed quantity of cooking oil for the raw material added therein to easily be agitated without rubbing;
a heater for heating the roasting container at an established temperature for the predetermined time;
a roasting agitator configured for both ends of a pivotal pole thereof to be supportably placed across the roaster to rotate and for agitating a collected raw material to equally be heated in the roaster rotated at a fixed velocity for the predetermined time with a power transmission attached thereto;
a shutter rotating clockwise and counter-clockwise with a separate power transmission at a fixed angle for the discharging gate to stay open for a predetermined time after sealing the discharging gate of the roaster for a fixed time;
a collection cooking container for collecting a class of condiments including various kinds of seasoning, sesame oil, and flavor each selectively dispersed from a plurality of condiment containers as well as for receiving a firstly processed raw material collected through the opening unit of the main body and discharged through the discharging gate of the roaster;
a condiment collection unit to store a class of condiments including various kinds of seasoning, sesame oil, and flavor, and to detachably collect a plurality of condiment containers for selectively providing a certain amount of seasoning necessary into the collection cooking container;
a cooking agitator configured for both ends of a pivotal pole thereof to be supportably placed across the collection cooking container and coupled thereon to rotate at a fixed rate with a separate power transmission such that the processed material collected into the collection cooking container can be uniformly mixed with the class of condiments and each wing of the second agitator can be positioned in upper direction at the completion of the process by each wing of the second agitator being arranged at least at a certain angle toward a horizontal plane to be easily released without the collection cooking container's being interrupted when it is necessary for the collection cooking container to be released; and
a controlling unit electrically connected to each member above to control each operation in sequence.

2. The roaster for seasoning marine algae in accordance with claim 1, wherein a guide rail is installed in both sides of the inner part of the opening unit in the main body to guide the collection cooking container when the collection cooking container is inserted and released.

3. The roaster for seasoning marine algae in accordance with claim 1, wherein a sensor is mounted on a rear side of an inner part of the opening unit to detect whether or not insertion is stably performed when inserting the collection cooking container.

4. The roaster for seasoning marine algae in accordance with claim 1, wherein the roasting agitator is comprised of a pair of at least two wings, each wing including a wing body and a wing member, the wing member coupled with one end of the wing body, extended in a longitudinal direction to the pivotal pole, and formed to have a twist at one end facing one end of the other wing member, the wing body extendedly arranged by direction of a radius from the pivotal pole with maintaining 180 degree of an interval angle to the other.

5. The roaster for seasoning marine algae in accordance with claim 1, the shutter further comprising:
a sealing plate to cover the discharging gate incised in a predetermined width in a longitudinal direction to the roaster;
a pivotal pole formed in a longitudinal direction on a one side of the sealing plate, the pivotal pole having both ends pivotally coupled to the main body such that the sealing plate circles at a predetermined angle;
a pair of light sensors to perceive a rotating position of the pivotal pole, each sensor attached around the pivotal pole to one wall of the main body supporting the pivotal pole;
a light isolating pole circulating with the pivotal pole to prevent each light sensor radiating and receiving the light, positioned at one end of the pivotal pole in the one wall of the main body with the light sensor attached thereto.

6. The roaster for seasoning marine algae in accordance with claim 1, wherein the collection cooking container is made of transparent synthetic resin for a mixing and cooking process to be checked outside by an operator.

7. The roaster for seasoning marine algae in accordance with claim 1, wherein the cooking agitator is comprised of a pair of at least two wings, each wing including a wing body and a wing member, the wing member coupled with one end of the wing body, extended in a longitudinal direction to the pivotal pole, and formed to have a twist at one end facing one end of the other wing member, the wing body extendedly arranged by direction of a radius from the pivotal pole with maintaining 178 degree of an interval angle to the other.

8. The roaster for seasoning marine algae in accordance with claim 2, wherein a sensor is mounted on a rear side of an inner part of the opening unit to detect whether or not insertion is stably performed when inserting the collection cooking container.
